(19) United States
(12) Patent Application Publication
(10) Pub. No.: US 2015/0298440 A1
(43) Pub. Date: Oct. 22, 2015

(54) THERMAL/ACOUSTICAL LINER

(71) Applicant: Cocoon, Inc., North Hampton, NH (US)

(72) Inventors: Mark Crotty, Rye, NH (US); Katherine A. McNamara, West Newbury, MA (US); Leo J. Crotty, JR., North Hampton, NH (US)

(21) Appl. No.: 14/186,355

(22) Filed: Feb. 21, 2014

Related U.S. Application Data
(60) Provisional application No. 61/767,443, filed on Feb. 21, 2013.

(51) Int. Cl. B32B 27/32; B32B 27/12; B32B 5/02

(52) U.S. Cl. CPC B32B 27/322; B32B 5/022; B32B 5/02; B32B 27/12; B32B 2262/0269; B32B 2307/102; B32B 2307/304; B32B 2307/21; B32B 2605/18

(57) ABSTRACT

A multi-layer thermal acoustical liner is breathable, hydrophobic, oliophobic and fire-resistant rated. The liner includes a central insulation core layer contacted on a first surface by a first highly breathable layer and on a second surface by a second highly breathable layer. The first and second highly breathable layers are preferably an ePTFE membrane. The first highly breathable layer is adjacent a facing layer while the second highly breathable layer is adjacent a backing layer. The backing and facing layers are preferably nylon and treated with a fluorocarbon surface treatment for water repellency, UV resistance and mold/mildew resistance. At least one surface of one of the first or second highly breathable layers may include a carbon printing pattern to provide ESD protection. The layers of the liner are laminated to one another.

### CROSS-REFERENCE TO RELATED APPLICATIONS

This application claims priority from U.S. Provisional Patent Application No. 61/767,443 entitled “Thermal/Acoustical Liner For Cargo Aircraft”, filed on Feb. 21, 2013 which is incorporated fully herein by reference.

### TECHNICAL FIELD

The present invention relates to a thermal acoustical liner for use, for example, in aircraft and other similar environments.

### BACKGROUND INFORMATION

Current thermal acoustical liners, for example those used in aircraft, suffer from various performance issues. The liners tend to trap moisture and contaminants, such as water, oil, sand, dust and pollutants against the air frame of the aircraft. These liners are not breathable/air permeable and this leads to accelerated corrosion damage.

The liners currently used also add more weight to the aircraft than should be required in order to deliver the necessary sound deadening and thermal insulation performance requirements. For example, the build out of an existing liner (in terms of weight/square yard) is as follows: the face fabric is 14-18 oz/yard (PVC coated polyester), the microlite fiberlite AA insulation is 0.60 lb/cu. ft. or approximately 7.2 oz./sq. yd, a 1.0 oz vinyl barrier, a 2.0 oz. backing fabric, and an additional 2.0 oz due to the quilting process result in a total (not including attachment means) of 26-30 oz. total dry weight per aircraft, or roughly 163-188 lbs per 100 sq. yards (typical aircraft application . . . such as a Chinook helicopter).

Additionally, the existing liners absorb moisture and hydrocarbon contaminants in the field, which adds significant additional weight to the aircraft when in use, as much as 50% or 81-94 lbs. per 100 sq. yards. Additionally, the thermal and acoustical performance of current liners is limited due to limitations of fiberglass insulation and the quilting assembly that is required, compressing the insulation and degrading its thermal and acoustic properties. Additionally, the fiberglass insulation fibers breakdown/degrade due to vibration (breakdown and compression of fiberglass) and absorption of moisture and oil/fuel contaminates. As the liner becomes contaminated with dust, lubricants, fuel, hydraulic fluid, a fire hazard can be created.

Accordingly, what is needed is a Thermal Acoustical liner material that does not trap moisture or contaminates, that allows for breathability/air permeation to prevent corrosion due to trapped moisture/condensation against the air frame, which is lightweight, which has improved thermal and acoustical performance, which can dissipate static charges rapidly, and which reduces the fire hazard.

### SUMMARY

The present invention features a multi-layer liner that comprises an high performance, Fire Resistant (FR), nonwoven, amorphous thermoplastic polyetherimide,(PEI)resin (or equivalent) insulation core layer with an upper surface and a lower surface; a first, high strength (high tear, tensile, and abrasion performance) highly breathable layer located on the upper surface of the insulation core layer, the first highly breathable, waterproof, filter layer constructed from an ePTFE membrane or equivalent; a second highly breathable layer located on the lower surface of the insulation core layer, the second highly breathable, waterproof, filter layer constructed from an ePTFE membrane or equivalent; a facing layer located on the first highly breathable layer, wherein the facing is constructed from a material that is fire-resistant; and a backing layer located on the second highly breathable later, wherein the backing is a highly breathable, fire-resistant rated material, wherein the layers of the liner are connected to one another with an adhesive lamination process.

The entire thermal acoustical liner system dissipates static charges through the use of an electrostatic dissipative carbon printed on the inside of both the face and backing layers of the lamination. The system is assembled by laminating the layers together in a 3 dimensional blanket that is not compressed or punctured. The entire liner system is approximately 30% lighter than the existing design and does not gain significant weight in use.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a detailed cross-sectional view of the multi-layer liner according to one embodiment of the present invention;

### DETAILED DESCRIPTION OF THE PREFERRED EMBODIMENTS

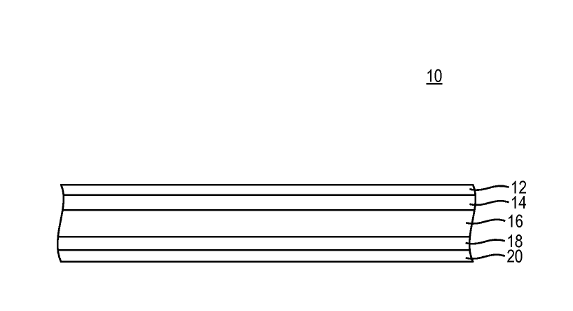

The present invention features a thermal acoustical liner 10, FIG. 1, which is breathable, hydrophobic, olio-phobic and fire-resistant. The liner is intended for use in a cargo aircraft on the interior airframe of the aircraft to help deaden acoustical noise coming from the airframe, although other uses are contemplated and within the scope of the present invention. The liner includes multiple layers, which are laminated to one another.

The acoustical liner 10 includes a facing layer 12 that is highly breathable and fire-resistant rated. The facing layer faces the interior (passenger and/or cargo) region of the aircraft. The facing layer must provide resistance to oil and water resistance with the overall 5 layer design having resistance to water entry pressures greater than 10 m of water and a surface oil resistance preventing the ingress of oils and other contaminants with surface tensions greater or above 21 dynes/cm. The facing 12 is preferably a high tenacity nylon 210 d fabric which has high strength and durability and light weight. The fire-resistant nylon may be a nylon coated with Alexium brand compound available from Alexium Inc. (or equivalent such as from P2i Inc.) This is a highly air permeable treatment that is gas plasma based and utilizes a microwave or RF energy source to make the chemical bonds to the nylon permanent in nature.

The facing 12 may also be treated with a fluorocarbon surface treatment for water repellency, UV resistance and mold/mildew resistance. An alternative embodiment uses woven, knitted or non-woven materials that are inherently flame retardant materials or by their polymer make up do not support combustion. Such materials can be aramid, polyimide, polyamidimide, fluoropolymer, melamine, glass and any other known fabric material that does not support combustion.

The facing 12 is in contact with a first highly breathable layer 14. The first highly breathable layer 14 is preferably an ePTFE membrane. The ePTFE material allows moisture to pass through the first highly breathable layer 14, while also blocking or preventing the first highly breathable layer 14 from retaining water and oil, as well as sand/dust and other contaminates down to 0.3 microns. The concept is not limited to ePTFE films but may also utilize any air permeable layer offering water repellency performance made from polyurethane or polyolefin.

An insulation core layer 16 contacts the first highly breathable layer 14. The insulation core layer 16 is breathable, hydrophobic and fire-resistant. The insulation core layer 16 is preferably a nonwoven Ultem Resin blended layer that is highly air permeable, hydrophobic and olio-phobic and which provides improved core thermal and acoustical performance characteristics vs. existing fiberglass cores. Ultem Resins are a group of amorphous thermoplastic polyetherimide (PEI) resins with elevated thermal resistance, high strength and stiffness, and broad chemical resistance. The insulation core layer 16 passes all required fire-resistance and smoke requirements.

A second embodiment includes the use of a non-woven aramid fiber core (such as Dupont Kevlar®, replacing the Ultem, to provide both the thermal and acoustical characteristics required, the light weight characteristic and the ability of the liner to provide “ballistic protection” for the sides of the aircraft.

The insulation core layer 16 contacts a second highly breathable layer 18. The second highly breathable layer 14 is preferably an ePTFE membrane. The ePTFE material allows moisture to pass through the second highly breathable layer 18, while also blocking or preventing the second highly breathable layer 18 from retaining water and oil, as well as contaminates down to 0.3 microns. The concept is not limited to ePTFE films but may also utilize any air permeable layer offering water repellency performance made from polyurethane or polyolefin.

The second highly breathable layer 18 contacts a backing layer 20, which is designed to face or contact the airframe of an aircraft. The backing 20 is a highly breathable, fire-resistant rated material. The backing 20 is preferably a high tenacity nylon 30 d-40 d woven fabric. The backing 20 may also be treated with a fluorocarbon surface treatment for water repellency, UV resistance and mold/mildew resistance. The backing 20 must provide resistance to oil and water resistance with the overall 5 layer design have resistance to water entry pressures greater than 10 m of water and a surface oil resistance preventing the ingress of oils and other contaminants with surface tensions greater or above 21 dynes/cm. An alternative embodiment uses woven, knitted or non-woven materials that are inherently flame retardant materials or by their polymer make up do not support combustion. Such materials can be aramid, polyimide, polyamidimide, fluoropolymer, melamine, glass and any other known fabric material that does not support combustion.

The multi-layered liner is designed to address all major performance deficiencies found in prior art liners.

The liner 10 will also preferably include electro-static discharge (ESD) performance. For example, preferably 1.0 second or better discharge of a 5000 volt charge is achieved using the federal rating and test method specified in FTTS-FA-009. In one embodiment, the ESD performance is achieved by utilizing a carbon impregnated ePTFE in at least one of the first and/or second highly breathable layers 14/18. In another embodiment, the ESD performance is achieved by using a carbon printing pattern on at least one surface interior of the facing 12 or backing 20. The overall 5 layer design will have electrical resistance performance around 1-100 MOhm when tested with 500 volts potential as per DIN test method 54345. The carbon printing pattern is preferably located on the surface of the facing 12 that comes in contact with the first highly breathable layer 14 or the surface of the backing 20 that comes in contact with the second highly breathable layer 18.

The liner also improves on corrosion prevention by maintaining a permanent barrier to water and oil and retaining high breathability (air permeability, MVTR), thereby assuring that moisture and water does not penetrate the liner and become trapped against the airframe and the electronic and hydraulic systems located against the airframe. Preventing water from coming in contact with the airframe reduces corrosion by reducing the water/electrolyte contact with the airframe and preventing oxidation. The liner of the present invention is an effective barrier/filter to contaminates (sand, dust, and pollutants like salts and sulfurs) down to 0.3 microns and also does not support the growth of mold or mildew. The first and second highly breathable layers 14/18 of the liner mitigate corrosion. When an ePTFE barrier membrane is used, the liner is highly breathable and will not hold or trap moisture against the air frame or within the core insulation.

The liner of the present invention features improved thermal and acoustical performance. The liner delivers an R 3.5 insulating value, which improves on the R 1.8 insulating value of prior art liners after quilting. The increase in thermal performance of the liner of the present invention represents a 100% increase over prior art liners. Further, the liner of the present invention provides acoustical performance of 10% or better across the entire relevant sound wave spectrum, than the currently available liners.

Assembly and connection of the layers of the liner is achieved through lamination, not by quilting as is done in prior art liners. Quilting tends to destroy the performance of the liner because the quilting process compacts the insulation layer and creates holes in the surface which allow water and oil to penetrate the liner. When the insulation is compacted, the insulative value (R value) decreases and its acoustical performance is degraded and the compacted insulation has an increased tendency to hold water and other contaminates due to the multiple punctures created by quilting.

In contrast, the present invention uses a lamination process that can be accomplished using a FR polyurethane (PU) adhesive or via thermal welding or binding. The lamination process is a five step process that builds up the component layers one at a time by bonding the individual layers together in a roll/heat/pressure/adhesive based process. The final laminated system is approximated 1 inch thick without interruptions, punctures or compressions (does not to degrade performance). The laminated system maintains high breathability/air permeation characteristics. Lamination also allows for in field repairs due to the uninterrupted flat surfaces of both the face and backing nylons. The surfaces allow adhesive backed nylon patch kits with adhesive backings to be applied and successfully bond providing an effective repair that cannot be achieved on irregular quilted surfaces.

The liner also features a lower dry weight that the prior art, with the liner preferably reducing the dry weight by 30%. An example of the product build out (in weight per square yard) for the multi-layer liner is as follows: a face fabric of 4.0-5.5 oz. nylon (facing layer 12), 0.25 oz ePTFE (first highly breathable layer 14), an insulation layer of Ultem nonwoven 1 inch 9.0 oz/sq. yd. (insulation core layer 16), 0.25 oz. ePTFE (second highly breathable layer 18), 1.5 oz of backing fabric (backing layer 20), as well as 1.0 oz. added as a result of the lamination and printing processes, for a total (without attachment means) of 16.0-17.5 oz. of total dry weight, or approximately 112.5 lbs. This reduced weight saves approximately 8 oz. per yard over the prior art liners (the composition and weight of the prior art liner is described in detail in the background). The present invention provides for a reduction in dry weight versus the existing fabric, which is estimated at 163 lbs/100 square yards versus the new liner which is 113 lbs/100 square yards. This reduction is approximately 50 lbs reduced weight for 100 square yards (approximately the amount of material to cover the airframe of a cargo aircraft such as a Chinook), which is approximately a 30% drop in weight per aircraft from the prior art liner to the liner of the present invention.

Also important is the weight difference between prior art liners and the liner of the present invention once the liner has been installed for a period of time. The liner of the present invention eliminates weight gain while the liner is in use (due to the accumulation of water, moisture, oil/fuel and other contaminates into the liner) and preferably obtains a maximum gain of 5% weight once saturated/aged. Prior art liners gain significant over time weight from water, oils and other contaminants. Existing liners can gain 50% of their original weight, causing a 163 lb liner to weigh 245 lbs over time. The combination of the layers and assembly method used in the liner of the present invention is such that the liner does not absorb the water, oils and contaminants as occurs with prior art liners. Since the liner of the present invention does not absorb water, oils and contaminants, the liner has been shown to exhibit only a 5% gain in weight over the same time period as the prior art liners, resulting in a liner that weighs approximately 124 lbs.

Although the multi-layer liner is described in terms of use in aircraft, as a liner, it is contemplated and within the scope of the present invention that the liner could be used for many other purposes. For example, the multi-layer liner could be used in watercraft, automobiles, military vehicles, or anywhere where traditional liners suffer from the performance issues outlined above.

The present invention creates a multi-layered liner material that addresses all of the problems encountered in the prior art. The liner of the present invention reduces the initial weight and weight over time of the liner, the liner reduces corrosion to the air frame by preventing moisture build up behind the liner (see FIG. 3), the liner increase thermal and acoustical performance, and the process of creating the liner through lamination creates a product that is superior and easier to fix that the prior art. The liner of the present invention preferably has a five year design life, is field repairable, is resistant to mold and mildew, is fire-resistant and is also ESD rated.

Modifications and substitutions by one of ordinary skill in the art are considered to be within the scope of the present invention, which is not to be limited except by the allowed claims and their legal equivalents.

The invention claims:

1. A multi-layer, light weight and highly breathable/air permeable thermal/acoustical liner, said multi-layer liner comprising:
an insulation core layer having an upper surface and a lower surface;
a first highly breathable layer disposed proximate and adjacent said upper surface of said insulation core layer, said first highly breathable layer constructed from an ePTFE membrane;
a second highly breathable layer disposed proximate and adjacent said lower surface of said insulation core layer, said second highly breathable layer constructed from an ePTFE membrane;
a facing layer disposed proximate and adjacent a surface of said first highly breathable layer that is opposite a surface that is proximate and adjacent said insulation core layer, wherein said facing is constructed from a material that is fire-resistant; and
a backing layer disposed proximate and adjacent a surface of said second highly breathable layer that is opposite a surface that is proximate and adjacent said insulation core layer, wherein said backing is a highly breathable, fire-resistant rated material, wherein said insulation core, said first highly breathable, said second highly breathable, said facing and said backing layers of said multi-layer liner are laminated to one another.

2. The multi-layer liner according to claim 1, wherein said first highly breathable layer and said second highly breathable layers are breathable and fire resistant.

3. The multi-layer liner according to claim 1, wherein said facing layer is resistant to oil and generally water impermeable.

4. The multi-layer liner according to claim 1, wherein said facing layer is constructed from a high tenacity nylon 210 d fabric.

5. The multi-layer liner according to claim 1, wherein at least one surface of said facing layer is treated with a fluorocarbon surface treatment.

6. The multi-layer liner according to claim 1, wherein said first and second highly breathable layers are an ePTFE membrane.

7. The multi-layer liner according to claim 1, wherein said insulation core is breathable, hydrophobic and a fire resistant.

8. The multi-layer liner according to claim 7, wherein said insulation core is constructed at least in part from a non-woven Ultem resin material.

9. The multi-layer liner according to claim 8, wherein said insulation core is air permeable, hydrophobic and oleophobic.

10. The multi-layer liner according to claim 6, wherein said insulation core is fabricated at least in part from a nonwoven, amorphous, thermoplastic polyetherimide, (PEI) resin.

11. The multi-layer liner according to claim 1, wherein said insulation core is fabricated at least in part from aramid fiber.

12. The multi-layer liner according to claim 1, wherein said backing is a highly breathable, fire resistant layer.

13. The multi-layer liner according to claim 1, wherein at least one of said first or second highly breathable layers include a carbon impregnated ePTFE material.

14. The multi-layer liner according to claim 1, wherein at least one of said first or second highly breathable layers includes a carbon printing pattern on at least an interior surface of said at least one of said 1^{st} or 2^{nd} highly breathable layers.
